(19) United States
(12) Patent Application Publication
(10) Pub. No.: US 2009/0037244 A1
(43) Pub. Date: Feb. 5, 2009

(54) INVENTORY MANAGEMENT SYSTEM

(76) Inventor: Greta Pemberton, New York, NY (US)

Correspondence Address: OSTROLENK FABER GERB & SOFFEN, 1180 AVENUE OF THE AMERICAS, NEW YORK, NY, 100368403, US

(21) Appl. No.: 11/831,061

(22) Filed: Jul. 31, 2007

(51) Int. Cl. G06Q 10/00; G06F 17/30; G06F 17/40

(52) U.S. Cl. 705/8; 705/28

(57) ABSTRACT

An inventory management system for identifying and locating items in a facility includes a plurality of identification tags, each of which includes identification information regarding an item to which each respective identification tag is attached, a memory device including information regarding all of the items in the facility, including image information for each item, an input device operable to receive information from a user, including a request for a desired item, a plurality of readers positioned around the facility, wherein each reader is operable to transmit an inquiry signal that triggers one or more identification tag to emit a response signal, the response signal including the identification information regarding the item to which each tag is attached, wherein the response signal is received by at least one reader of the plurality of readers; and a controller connected to the plurality of readers and the input device, the controller being operable to control the readers to emit the inquiry signal and to provide location information indicating a location of the desired item requested by the user based on the response signal received by the reader; wherein the controller retrieves image information for the desired item from the memory device and wherein the location information and image information related to the desired item is displayed to the user of the system.

### BACKGROUND OF THE INVENTION

1. Field of Invention

The present application relates to an inventory management system for locating and tracking inventory items in a facility. In particular, the present application relates to an inventory management system that tracks usage of inventory items and aids users in locating and identifying particular items.

2. Related Art

In any large facility, such as a hospital, warehouse, or even a retail store, it is useful to be able to locate and track the usage of items in the facility. However, in such large facilities, the volume of items to be tracked and the large number of employees or others who handle these items may make it difficult to pinpoint an item's location at any given time. Similarly, it may be difficult to keep an accurate, and up to date, count of the stock of any particular item for inventory purposes.

For example, hospitals typically have a multitude of medical supplies on hand at any give time. These items are typically stored in various storage rooms and storage areas that are spread throughout the facility. Thus, just keeping track of which items are stored in which storage area can be difficult. Further, there are a large number of people within the hospital who use these items and may, or may not, return them to the proper storage area after use. Thus, it may be very difficult to locate any particular item unless one already knows where it is stored. Even if one does know where an item is supposed to be stored, there is no guarantee that the item will be there, since it is not uncommon for items to be lost or otherwise misplaced. In light of this, it is not surprising that it is equally as difficult to accurately track inventory levels of particular items as well. In addition, it is not uncommon for a staff member or employee to be asked to retrieve an item that they may not personally be familiar with. In this case, there is an added obstacle for the employee since they may not be exactly sure what the item that they are looking for looks like. In such an environment, where delay in locating a critical piece of equipment can literally mean the difference between life and death, it is particularly crucial that employees be able to quickly identify and locate desired supplies and that accurate inventory records are kept to ensure that supplies are not exhausted without replacement. Similar problems may arise in other environments such as large warehouses, factories or even retail stores.

Thus, it would be beneficial to provide an inventory management system that overcomes the problems described above.

### SUMMARY OF THE INVENTION

It is an object of the present invention to provide an inventory management system for identifying, locating and tracking supplies of items in a facility.

An inventory management system for identifying and locating items in a facility includes a plurality of identification tags, each of which includes identification information regarding an item to which each respective identification tag is attached, a memory device including information regarding all of the items in the facility, including image information for each item, an input device operable to receive information from a user, including a request for a desired item, a plurality of readers positioned around the facility, wherein each reader is operable to transmit an inquiry signal that triggers one or more identification tag to emit a response signal, the response signal including the identification information regarding the item to which each tag is attached, wherein the response signal is received by at least one reader of the plurality of readers; and a controller connected to the plurality of readers and the input device, the controller being operable to control the readers to emit the inquiry signal and to provide location information indicating a location of the desired item requested by the user based on the response signal received by the reader; wherein the controller retrieves image information for the desired item from the memory device and wherein the location information and image information related to the desired item is displayed to the user of the system.

Other features and advantages of the present invention will become apparent from the following description of the invention which refers to the accompanying drawings.

### BRIEF DESCRIPTION OF THE DRAWING(S)

FIG. 1 is a block diagram of an inventory management system in accordance with an embodiment of the present invention;

FIG. 2 is a block diagram of an exemplary memory device of the inventory management system of FIG. 1;

FIG. 3 is a block diagram of an exemplary controller of the inventory management system of FIG. 1;

FIG. 4 is a block diagram of an exemplary terminal of the inventory management system of FIG. 1;

FIG. 5 is a block diagram of an inventory management system in accordance with another embodiment of the present invention; and

FIG. 6 is a block diagram of an inventory management device in accordance with another embodiment of the present invention.

### DETAILED DESCRIPTION OF EMBODIMENTS OF THE INVENTION

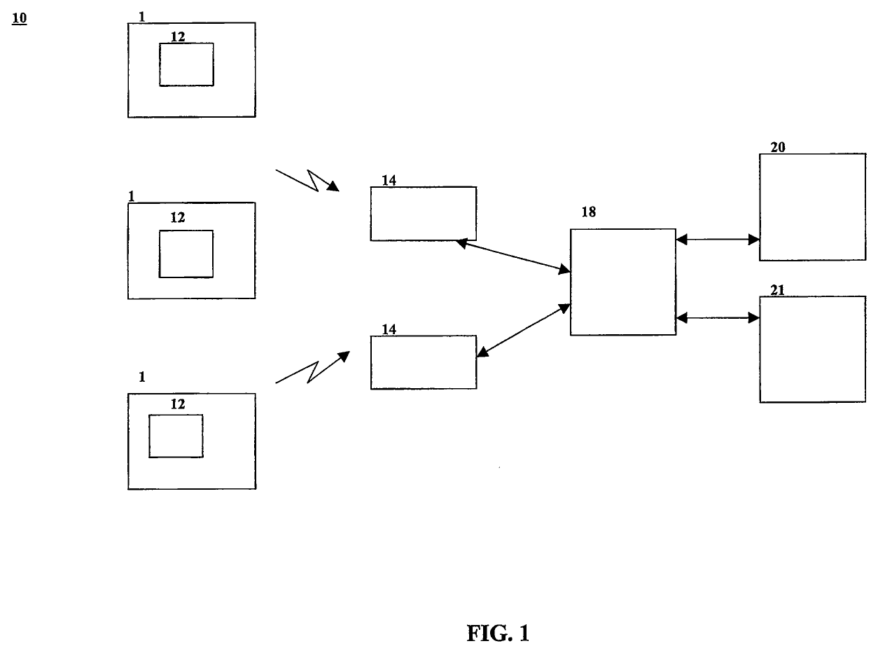

An inventory management system 10 in accordance with an embodiment of the present application is described with reference to FIG. 1. In a preferred embodiment, every supply item 1 in a facility, such as a hospital, for example, is preferably provided with an RFID tag 12 attached thereto. The RFID tag 12 on each item 1 includes information that identifies the specific item 1 to which it is attached. The system 10 preferably also includes a plurality of RFID readers 14, or transceivers (transmitters/receivers), which are positioned throughout the facility. In particular, one or more readers 14 are preferably positioned in each storage room, or other storage area, in the facility, in which items 1 are stored. The readers 14 are able to send and receive signals to and from the RFID tags 12. A controller 18 is provided to control communication between the tags 12 and the readers 14 such that the controller 18 can determine the location of any particular tag 12, and thus, the item 1 to which it is attached. The controller 18 is also connected to at least one memory device 21 that includes item information regarding each of the items 1 in the facility including image information such as a photograph of each item. The controller 18 preferably is operable to retrieve information, including the image information, regarding a specific desired item 1 and to provide it to a user of the system to aid the user in identifying the item, and information about the item while also indicating the specific location of the item. In a preferred embodiment, at least one terminal 20 is provided to allow for user interaction with the system 10. That is, the terminal 20 allows the user to input a request for a specific item 1, for example, into the system and provides information regarding the requested item to the user. This information preferably includes the image information and location information regarding the specific requested item 1. The controller 18 also tracks the availability of items 1 to ensure that inventory information is current.

Generally, a user enters a request for a particular item, or items, into the system 10 via the terminal 20. The controller 18 receives the request and retrieves information regarding the item from the memory device 21. Preferably, image information, such as a photograph of the requested item 1 is displayed to the user via the terminal 20. In this manner, the user is reminded of the appearance of the item 1 and thus is able to easily identify the requested item 1 on sight. In addition, the controller 18 preferably triggers the readers 14 to emit an inquiry signal, which may include identification information related to the requested item 1. This identification information is preferably retrieved from the memory device 21 by the controller 18. The inquiry signal triggers at least one of the tags 12 to emit a response signal which is received by one or more of the readers 14. In a preferred embodiment, a tag 12 will emit a response signal when the identification information in the inquiry signal matches that stored in the tag 12. Alternatively, the inquiry signal may not include the identification information of the desired item 1. In this case, any tag 12 that is within the range of a reader 14 will emit a response signal that includes identification information identifying the item 1 to which the tag 12 is attached. The readers 14 receive these response signals, and send response signal information to the controller 18. The response signal information preferably includes the identification information included in the response signal(s) of each of the tags 12 and reader information that indicates which reader 14 received which response signal(s). The controller 18 then preferably determines which reader 14 received a response signal from the tag 12 attached to the requested item 1 by matching identification information from the response signal with that retrieved from the memory device 21 for the requested item. The controller 18 then determines the location of the requested item 1 and sends location information to the terminal 20 to be displayed to the user. Thus, the user is provided with both image information that indicates what the requested item 1 looks like and location information specifying the present location of the requested item as well as content regarding the item and its use, assembly and maintenance.

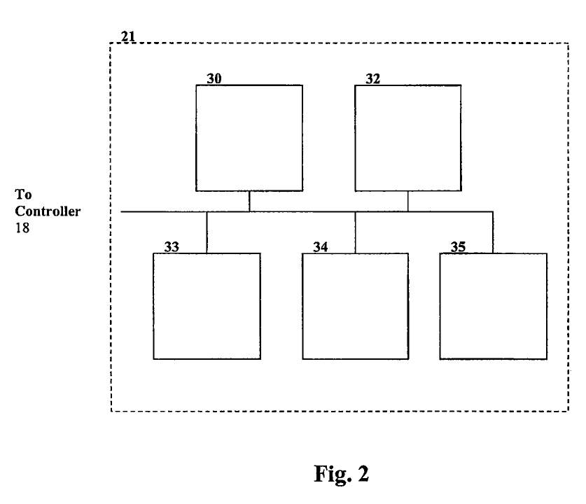

The memory device 21, as illustrated in FIG. 2, for example, is preferably connected to the controller 18 and includes one or more databases or other memory elements for electronically storing information. Preferably, the memory device 21 includes an item database 30 in which information regarding each of the items 1 in the facility is stored. In particular, for each item 1 in the facility, the item database 30 stores unique identification information that identifies each item. The identification information may include type information that indicates the type of item 1. For example, the type information may identify an item as a scalpel, as opposed to a bandage or hypodermic needle, for example. Sub-type information may also be included to indicate whether the scalpel is a scalpel of one size or another size, for example. The sub-type information may also distinguish between different brands of the same size item, for example, as well. In addition, the item database 30 stores the image information for each item 1.

The items 1 in a facility may be a wide variety of different things. For example, in a hospital setting, the items 1 may include sterile items such as surgical instruments and implants, for example. In addition there may be non-sterile supplies such as machinery, equipment, laboratory supplies, housekeeping materials etc. Further, supplies may be stored in packs or kits as well.

The image information stored in the database 30 preferably includes photographs of each item 1 in its stored state, in its assembled state, disassembled state, packaged state, if applicable, and in its stored position. The photographs allow a user to see what each item 1 looks like so that they can identify items easier. The photograph of the item 1 in its stored position allows users to see the storage room or storage area in which each item 1 is stored and what else is stored with each item. In addition, in this photograph, the item is preferably highlighted in some way in order to clearly show its position relative to other items in the photograph. The photograph of the requested item 1 in its assembled state, if applicable, will also remind user how to assemble the item.

Further, the item database 30 includes usage information regarding the use, maintenance, assembly, cleaning and/or decontamination, sterilization information for each item 1. Any personal protection equipment (PPE) necessary when using each item may also provided in the item database 30 since some items 1 may represent biological or chemical hazards. This information may be presented to the user upon request via the terminal 20 or automatically, if desired. In addition, pricing information regarding the price to be charged to clients for the requested item 1 may also be included in the item database 30. Further, any specific pricing instructions for the item 1 may also be stored in the item database 30. For example, some items may require input of certain information to aid in properly charging for the item 1. All of the information in the item database 30 may be retrieved by the controller 18 and displayed to the authorized user via the terminal 20. In a preferred embodiment, access to certain information such as pricing information may be limited. In addition, vendor information for each item 1 is included in item database 30. This information identifies the vendor of each item 1 and may also include contact information, such as a web address or other information to allow users to contact the vendor to ask questions, request additional information or re-order items. In addition, any recall or expiration information regarding all of the items 1 is also stored in the database 30. The controller 18 may also periodically calculate the total number of each type or subtype of item 1 stored in the database 30 and compare it to a predetermined minimum amount for each type or sub-type, of item to determine if reordering of the item is necessary. If so, the controller 18 may automatically reorder the item, preferably using the contact information for the vendor stored in the database 30. The controller 18 may also generate a report for an administrator to indicate that reordering is necessary.

The memory device 21 also preferably includes a staff database 32 which includes information regarding all employees of the facility. The staff database may include preference lists that identify the preferred supplies or items that are used by selected employees. For example, in a hospital setting, doctor procedure preference lists may be stored for each doctor or may be generalized if a particular surgeon's preferences have not yet been documented. These preference lists/templates will include pick lists that identify all of the supplies that are preferred by each surgeon in the hospital, for example, and as they relate to particular procedures and include special requests as they occur on a case by case determination. Thus, when a doctor is scheduled for surgery, a nurse or technician can request a preference list for the doctor via the terminal 20. The system 10 can then display the preference list and any desired information, including the location of each item 1 to the user and photographs of each item. In a preferred embodiment, the list is presented to the user in order of convenience in locating the item. That is, the items are presented in an order that will maximize efficiency when gathering the items on the list, factoring in the location of the user picking for the case. For example, there may be a number of areas or rooms in which procedures are done. In a preferred embodiment, the system 10 provides location information for items on the preference list in an order that is optimized based on the location of the user, which may be determined based on the location of the terminal 20, for example. In a preferred embodiment, the preference list will include both a list of items to be used in the procedure and a list of so-called “hold items” which are items that may be used, but should not be opened unless requested by the doctor. These hold items are preferably indicated in a different font or some other unique matter such that a nurse or other user gathering items for a procedure knows not to open these items until requested. These hold items are preferably grouped together in, or just outside, of the operating room until requested.

In addition, the staff database 32 may include certain rights information related to each employee that may indicate the scope of access that the employee has to view or change information in the memory device 21. This is discussed in further detail below. The staff database 32 will also preferably include contact information for all members of the staff as well, including pager numbers, office numbers and locations etc. Further, while surgeon preferences are specifically discussed above, non-surgeons may also specify preferences. For example, anesthesiologists may also have preference lists as well. In addition, photographs of all of the staff members may also be stored in the database 32. These photographs may be requested by a user via the terminal 20 as well, so that staff members can easily identify each other even if they haven't met.

A client database 33 may also be provided in the memory device 21. This database 33 includes information regarding all clients of a facility and may include history information and billing information, for example, for each client. For example, in a hospital setting, the client database 33 may include information regarding all of the patients in the hospital. Medical history information for each patient may be included. Further, billing information for each patient is preferably included. The billing information may be updated by the controller 18 as items 1 are used for the treatment of the patient, if desired.

Further, the memory device 21 preferably includes a scheduling database 34, for example, which stores scheduling information regarding all scheduled procedures or actions being performed in the facility. For example, in a hospital, the scheduling database 34 may store information regarding all surgeries being performed. This may include the operating room being used, the patient involved, the surgeon performing the surgery and the surgical nurses or other staff assisting in the surgery. A standard equipment list for each procedure may be provided. Alternatively, as noted above, a preference list associated with the surgeon may be retrieved from the staff database 33. Further, the database 34 may include photographs of preferred room arrangements for each procedure scheduled. These photographs may be requested and viewed by users via the terminal 20 to help set up the operating room before the procedure.

In addition, a reference database 35 is preferably also included in the memory device 21. The reference database 35 preferably includes various medical reference information such as entries from medical dictionaries and other resource books. Further, the database 35 preferably stores hospital policy and standard information, rules and guidelines as well. In addition, in a preferred embodiment, the database 35 preferably also includes translation information including translations of various commonly used medical terms and/or instructions in a variety of languages. All of this information is preferably presented to a user upon entry of a request via the terminal 20, for example.

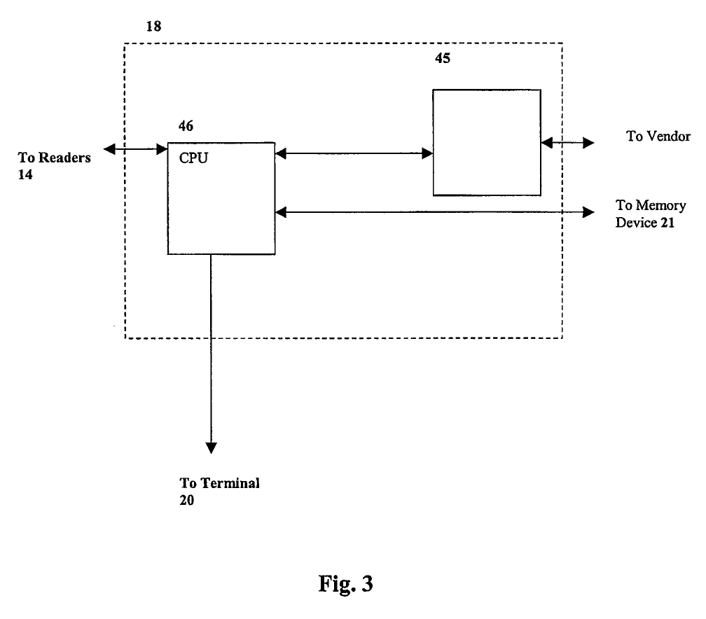

The controller 18 may be a general-purpose computer, or server, or any other suitable device, such as a microprocessor, for example. The controller 18 controls communication between the tags 12 and the readers 14 in order to locate particular items 1 in the facility. The controller 18 further retrieves information regarding a requested item 1 and provides it to the user via the terminal 20. The controller 18 also preferably includes a communication component 45, as illustrated in FIG. 3, for example, or network connection that allows the controller 18 to communicate with external devices, such as servers or computers at a vendor site to request information and/or to order or reorder additional items or supplies from the vendor. This may be done via the Internet, if desired. Further, the controller 18 allows users to communicate with vendors in real time to ask questions or get help setting up or using items 1. The controller 18 preferably includes a logic device or devices, such as a CPU 46, for example, that allows the controller to receive information and requests from and to provide control signals to the readers 14 and terminal(s) 20 to operate as described above.

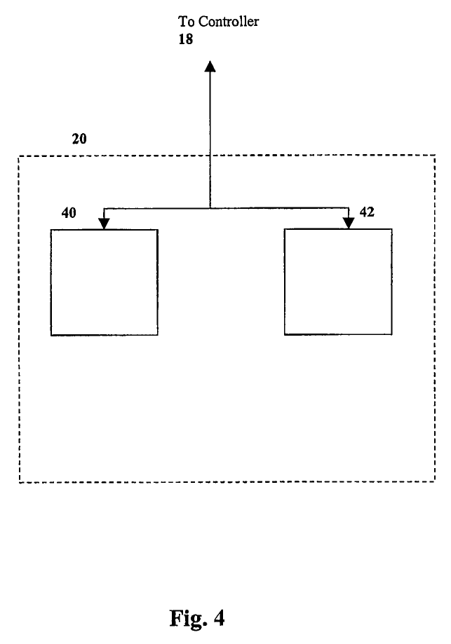

FIG. 4 illustrates a more detailed view of the terminal 20 in accordance with an embodiment of the present invention. The terminal 20 is preferably operable to allow users to interact with the system 10. In a preferred embodiment, multiple terminals 20 are provided and are spread out over the facility in any desired manner to allow for easy access no matter what part of the facility a user is in. Each terminal 20 preferably includes, or is connected to, an input device 40, such as a keyboard, touch screen, mouse, or any other suitable device. Alternatively, voice recognition may also be included in any input device 40. The voice recognition technology may also include an authentication feature that allows for identifying and authorizing users. In addition, each terminal 22 may include a display 42, which may be used to display information regarding the requested item 1 including the image information and location information provided by the controller 18. In particular, the input device, such as the keyboard 40, allows a user to input a request for a specific item 1, or items, into the system 10. The display 42, on the other hand, allows the user to view information regarding the requested item that is provided by the system 10 including the location information which indicates the precise location of the requested item 1 and the image data related to the requested item. As noted above, at least one photograph of the requested item 1 is preferably retrieved from the item database 30 and is displayed to the user. Further, as noted above, multiple photographs may be displayed to the user so that the user can see what the item looks like when assembled and how and where it is stored, as well. The terminal 20 may be a personal computer (PC) or any other suitable device and is preferably connected to the controller 18 via a computer network such as a local area network (LAN) or Intranet, for example. Alternatively, the terminal 20 may be a portable electronic device, such as a personal digital assistant (PDA) or other similar device. Such electronic devices typically include an input device such as a modified keyboard and a display similar to those described above. In this case, the portable electronic device is preferably connected to the controller 18 by a wireless link.

As noted above, the RFID tags 12 preferably store identification information that is unique to each specific item 1. Each of the items 1 preferably has a tag 12 attached thereto, or otherwise associated with it. The identification information in the tag 12 preferably matches the identification information for each respective item 1 that is stored in the item database 30. Further, the RFID tags 12 may store additional information related to the specific status of each item 1. For example, some items 1 in the facility may be reusable equipment that needs to be sterilized after each use. The RFID tag 12 on such items 1 may store information that indicates whether the item 1 is sterile. In this case, the tag 12 should include an editable memory that allows the sterilization state, for example, to be changed when appropriate. The tags 12 preferably also include a tag transceiver (transmitter/receiver) that is operable to allow for communication between the tag 12 and the readers 14. Such tag transceivers are well known and need not be discussed in detail. The tag transceiver in each tag 12 preferably includes a receiver that receives a signal, such as the inquiry signal from a reader 14, for example. The tag transceiver also includes a transmitter that transmits a signal, such as the response signal in response to the inquiry signal. The response signal may include the identification information unique to the item 1 to which the tag 12 is attached as noted above. In addition, the status information may also be included in the response signal. The RFID tags 12 are preferably passive type RFID tags, however, they may be semi-passive and/or active tags as well. In a preferred embodiment, the tags 12 are sufficiently sturdy to withstand the sterilization process and continue to work. Thus, the tags 12 need not be removed for sterilization. Further, the tags 12 may be attached directly to the item 1 or may be attached to packaging of the item 1. In one non-limiting example, the tags 12 or components thereof may be constructed using a soft lithography technique, which is known in the art.

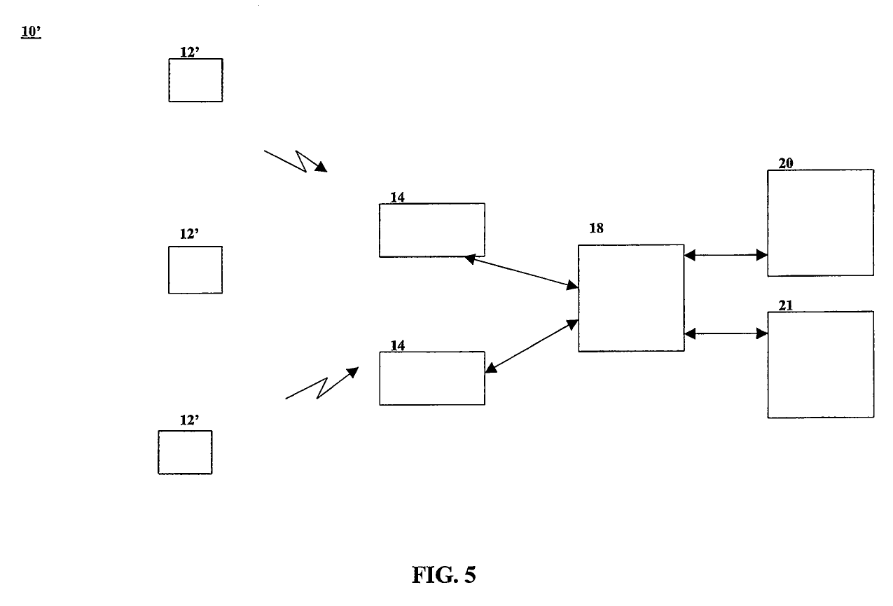

In an additional, or alternative embodiment illustrated in FIG. 5, the inventory management system 10′ may include RFID tags 12′ that are attached to shelves or bins in a storage area or other area. These RFID tags 12′ may simply include the type information, and/or sub-type information for the items and each item 1 in the bin, or shelf, is associated with the tag 12′. In this case, the tags 12′ may be attached to the shelf or bin, rather than the individual items 1. For example, one such tag 12′ may be placed on a shelf that is used to store scalpels, while another tag 12′ may be placed on another shelf used to store bandages. These tags 12′ would thus include the type information, or sub-type information of the items 1 stored in, or on, the shelf or bin. In addition, this type information is preferably included in the response signal emitted by these tags 12′. Thus, any response signal from these tags 12′ will indicate the general type and/or subtype of items to be found in the area of the tag 12′. Image information may also be associated with these tags 12′ as well, and may be included in the item database 30, preferably illustrating all of the items 1 stored on a particular shelf or bin where the tag 12′ is located. In this case, the user may simply make a request for a type and/or sub-type of item via the terminal 20. The inquiry signal from the transceivers 14 may identify only type/sub-type information. This would trigger, either specific tags 12′ or all tags 12′ to respond, depending on whether the tags 12′ match information from the inquiry signal with internal information as described above, or whether the controller 18 does such matching based on the information in the response signals. The user would then be provided with information including the image information and the location information of the shelf or bins in which, or on which, the scalpels, for example, are stored. Further, image information and location information for all such scalpels in the facility may be displayed as well if such scalpels are stored elsewhere. Further, by attaching tags 12′ to the shelves or bins in a storage area, there is a reduction in the number of tags 12′ and the number of tag searches since multiple items in a group are identified by one tag in the system 10, and thus, the amount of radio frequency radiation necessary to locate desired items is reduced while still allowing items 1 to be quickly identified and located.

The readers 14 may be stationary and positioned strategically throughout the facility, or they may be portable hand held devices, if desired. The portable readers 14 are discussed in further detail below. The location of the tag 12 attached to the requested item may be determined by the controller 18 based on the response signal, or signals, received by the readers 14. For example, one or more readers 14 may be used to triangulate the position of a particular tag 12 that responds to the inquiry signal with a response signal. Alternatively, the location may be estimated by the time between the inquiry signal and the response signal from the tag 12, or based on the number of transceivers 14 that receive a response signal or the strength of the response signal. Naturally, any combination of these locating techniques may also be used. Any other means of locating the item based on the tag may also be used.

As noted above, each of the readers 14 may send response signal information to the controller 18 upon receiving a response signal or signals. The response signal information preferably includes any identification information included in the response signal, or signals, received by the reader 14 along with reader identification information that indicates the identity of the reader 14 that received the response signals. The reader 14 may be linked to the controller 18 by a cable or wire in a LAN, for example, or may be wirelessly linked to the controller 18, if desired. The location of the tag 12 that transmitted a response signal that indicated that it was associated with the requested item 1 is preferably displayed to the user on the display 42 of the terminal 20.

Further, as noted above, a hand held portable reader 14 may also be provided in the system 10. The portable reader 14 is generally similar to the readers 14 described above, however, it is sized to allow it to be easily carried and preferably has a somewhat smaller range than that the pre-positioned readers 14 discussed above. The range of the portable reader 14 may be a 4 foot square cube, for example, but is not limited to this specific range. The portable reader 14 is preferably used to keep track of items 1 in a more localized area, such as an operating room, for example.

In an exemplary embodiment, at the beginning of an operation, all of the items 1, or equipment, to be used during a surgical procedure may be identified by the portable reader 14. Preferably, the supplies to be used for the surgery are gathered in a particular area, such as in a bin, for example, and then, the portable reader 14 is passed over all of the items. The portable reader 14 sends out an inquiry signal and receives a response signal from any tag 12 attached to the items 1, or supplies, to be used during the surgery. The sterilization status of each supply may also be collected by the portable reader 14. Further, the portable reader 14 is also passed over any hold items, in or near, the operating room as well. All of this information may be forwarded to the controller 18 for storage until after the surgery is done. After the procedure is complete, the portable reader 14 may be passed over the patient's body to identify any items 1, such as clamps or sponges, for example, that are still in the patient's body prior to closing the incision. Further, the portable reader 14 may be passed over a garbage receptacle to track all of the items 1 that have been used and discarded during the procedure. This information regarding used items may also be forwarded to the controller 18 as well. In addition, unused items may be grouped together after surgery and the portable reader 14 passed over them to identify all items 1 that were not used. The portable reader 14 preferably includes a display (not shown) that allows a user to view information regarding the items identified in this manner. In addition, an input device (not shown) may be provided to allow a user to make notes regarding the items 1 scanned by the portable reader 14. This may include notes regarding how and why items 1 may have been opened but not used. The portable reader 14 is preferably connected to the controller 18, either by a cable, or wire in a LAN, for example, or via a wireless connection, if desired. The controller 18 may compare the beginning list of all items 1 to be used with the information regarding discarded items and information regarding any remaining items that have not been used to ensure that all items are accounted for. Alternatively, this comparison may take place locally in the portable reader 14 as well, in which case the portable reader 14 preferably includes a logic device as well. The controller 18 preferably updates inventory information regarding the items 1 used during the surgery. That is, these items 1 may be removed from the item database 30 and the total count of the items is decreased in accordance with used items. Cost information regarding the items 1 used may be added to the billing information for the patient, or customer, in the customer database 33.

In another embodiment, the operating room may be scanned prior to surgery either with the portable reader 14 or using a stationary reader in the room. All items in the room including supplies, equipment and medication are then identified and may be compared to a surgeon preference list or preferred setup. Any missing items identified as absent from the room scan may be highlighted and users alerted. The missing items may be identified and photographs of the missing items displayed to the user to aid them in finding them. Similarly, after a surgery, the operating room can be scanned again to identify any items in the room that should not still be in the room and to identify any supplies that should always be in the room that are missing. Further, in preferred embodiment, a terminal 20 is either provided in the room or a connection for a wireless device provided such that a user can enter information regarding re-supply of the room after surgery.

In another embodiment, the portable reader 14 may be used to ensure that items are properly returned to their storage area. For example, if a staff member notices items 1, or equipment, that are out of place, even if they do not know exactly what the items are, the portable reader 14 may be used to activate the tag 12 on the item 1. Based on identification information from the tag 12, the portable reader 14 will be able to identify the item. The user may then use a terminal 20 to request information regarding the item in the manner described above, including the photograph of the item 1 in its stored position so that the user can return the item to its proper stored position. If desired, the portable reader 14 may also be adapted to display the image information from the controller 18 directly such that the user need not use a terminal 20 if desired.

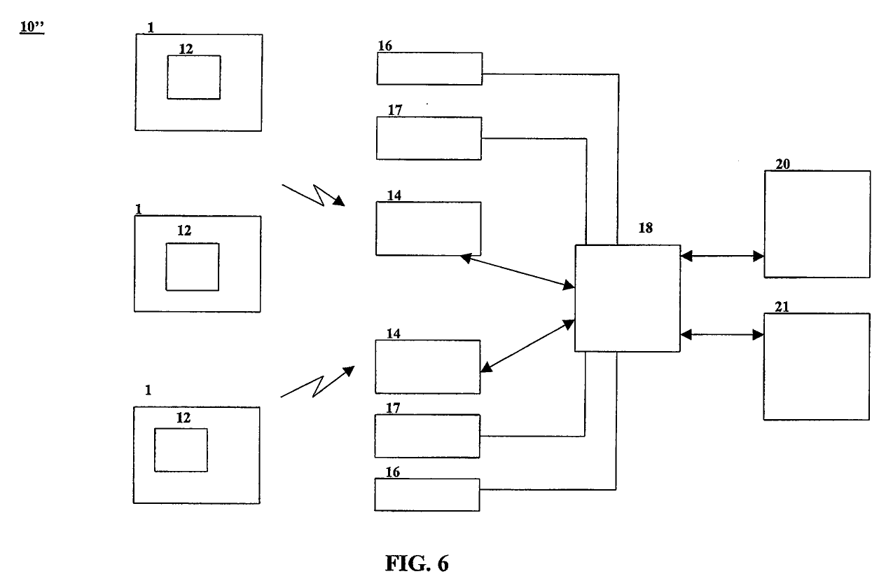

FIG. 6 illustrates an alternative embodiment of an inventory management system 10″ in accordance with an embodiment of the present invention. The system 10″ is similar to that in FIG. 1 except that it also includes a plurality of cameras 16, preferably including at least one camera 16 in each storage area. The cameras 16 may be used to provide real time image information, which preferably includes a current location, snapshot image of any of the items 1 in the facility. For example, once the location of the requested item 1 is determined as noted above, a camera or cameras 16 may be used to obtain a real time image of the item 1 in the storage area or room. The cameras 16 are connected to and controlled by the controller 18. In a preferred embodiment, the real time image may be highlighted or otherwise enhanced to indicate the exact position of the requested item 1 in the room. This real time image information may be displayed to a user via the display 42 in the terminal 20, for example, to allow the user to easily identify and locate the requested item 1. The real time image information provided by the camera 16 is particularly useful in a situation in which an item is not in the place where it is expected to be. In this case, the photographs that are stored in the item database 30 regarding the item may not accurately reflect the appearance of the item in its present position. Thus, the user is preferably presented with the option to view the real time snapshot of the desired item. Further the system 10 may compare the location information generated with stored location information regarding the item 1 and alert the user if the item is not in its usual position. The stored location information is preferably stored in the item database 30 or may be generated based on the image information regarding the item that is stored in the item database 30.

In addition, multiple designators 17 may be provided in the system 10″. In a preferred embodiment, a designator 17 is positioned in each storage room or area. Each designator 17 is preferably controlled by the controller 18 to designate the location of the requested item in the storage area. For example, the designator 17 may be a laser or other light source directed at the requested item 1 in the storage area.

As noted above, the controller 18 may also be used to control inventory for each item 1 or type/sub-type of item 1. That is, the memory device 21 may also store inventory information for each type, or sub-type of item 1 in the facility. As a requested item 1 is located, as noted above, and used, the user may enter this information into the system 10 via the keyboard for example and the controller 18 updates inventory information. That is, the controller 18 removes the used item from the database 30 and updates a count of that type or sub/type of items to reflect the fact that the item was used. Alternatively, where an item is detected in a garbage receptacle, for example, after it is used in surgery, the portable transceiver 14 may notify the controller 18 that the item has been used and the inventory information regarding the item may be updated automatically. As noted above, the controller 18 preferably keeps track of the total number of each type, or sub-type, of item 1 included in the database 30. The controller 18 may also be operable to generate inventory reports and supply usage reports. These reports may be provided to administrators of the facility in order to analyze and improve efficiency. In addition, the controller 18 may automatically reorder items when the inventory information indicates that a supply of the type or sub-type items has dropped below an acceptable predetermined level. The controller 18 may contact the vendor electronically via the communication component 45, for example, using contact information from the database 30 for example.

In light of the extensive information available on the system 10 it is preferred that users log into the system 10 to maintain security. Preferably, a user name and password will be assigned to each user and stored in the staff database 33. Alternatively, as noted above, a user may be authenticated based on their voiceprint. Other possible security features may include fingerprint or retinal scanning. Users may be granted limited access, if desired, or granted full access. For example, in a preferred embodiment, all users will be able to enter information regarding an item to be located and be provided with the location of the item by the system 10. However, it may be advisable to limit access to inventory records and to billing information. Thus, for example, access to inventory information may be limited to department heads, or head nurses and administrators, for example. Preferably, surgeons will be given access to their own preference information and be able to modify them, request that they be added/deleted from other facilities in which they have privileges to operate in and to request authorization to access inventory information when a preferred item is in not present in the facility. Thereafter, the surgeon could search the inventory information for a replacement item or to request that the item be ordered. Further, it may be useful to give nurses, nurse managers, physician assistants, etc. access to surgeon preference information, as well, so that they can easily view and modify preferences based on experience with particular surgeons, for example. Further, while others may be able to view certain information, administrators may be the only ones entitled to modify certain information such as billing or payment information for each patient, for example. Further, administrators may wish to limit access to inventory information since such information may be manipulated in order to conceal theft, for example of certain expensive items. Further, a log of user's who have logged in and located items may also be maintained which may be useful in tracking down lost or perhaps stolen equipment. That is, based on the last person to make a request to locate an item 1, it may be possible to track down the location of a missing item. In addition a log of searches requested on the system 10 may be maintained. Managers may review such logs in order to determine which items are frequently searched, and thus, adjust training to ensure that employees are better prepared to find these items. In addition, records are kept regarding items 1 that are being repaired and/or service for routine maintenance. These records are preferably kept in the database 30.

In addition, in a preferred embodiment, the system 10 allows surgeon preferences to be forwarded to other facilities in which the surgeon has privileges. In addition, any items missing from any surgeon preference list may be identified and an explanation given if item is for example, on recall, out for repair, being serviced, currently in use elsewhere so not currently available, and alternatives may be suggested. Alternatively, as noted above, the surgeon may access inventory information to search for suitable alternatives. In addition, the system 10 may be able to communicate with other systems in other nearby facilities in order to access information regarding all of the items that are stored in those facilities. This may be particularly useful in a situation where surgeon preference items are not present in a particular facility. This is particularly useful when surgeons routinely work in different hospitals for example, or where a doctor is visiting a facility for training or a seminar. However, as is noted above, security in such external communications is critical to ensure that confidential information is maintained in confidence.

Further, it may be desirable to allow certain users or staff members to enter their own notes regarding information related to other users or staff. For example, nurses or nurse managers may be authorized to enter their own notes regarding surgeon preferences. Preferably, only the individual and perhaps his or her immediate supervisor will be able to view these notes. Of course, access may be granted as desired.

In order to minimize the transmission of radio signals within the facility, the storage rooms in which the items 1 are typically stored may be lined with an insulating material that reduces or eliminates the leakage of the inquiry and response signals outside of the storage areas. In addition, users may opt not to emit an inquiry signal via the readers 14 if they believe that the image information will provide sufficient information to identify and locate the item 1 they are seeking. In addition, as noted above, the use of the modified tags 12′ described above will reduce the total number of tags 12 necessary to locate items 1 and thus results in reduced emissions of radio frequency signals while still allowing for identification and location of an item.

In addition, as noted above, the user is preferably permitted to retrieve usage information about any item 1, as well. This is preferably accomplished using the terminal 20, which may be implemented as a PDA, for example. The usage information may include instructions and/or user manuals as noted above. In addition, the user may request and view information regarding trouble shooting problems with the item and/or maintaining the item. Further, there may be instructions regarding how to disassemble, recycle and/or dispose of the item and any special clean up instructions as well. This may be important for some items as they may represent biological of chemical hazards either before or after use. The information may also include use limitations for the item, such as directing disposal of the item after a certain number of uses. Further, there may be sanitation and/or sterilization instructions unique to the item. In addition, the user may contact the vendor of the item, via the Internet, for example, to request information. Alternatively, there may be a video feed to the vendor via the communication component 45 of the controller 18 as well, in which case, the terminal 20 is preferably provided with a camera as well. Any such external connection is preferably encrypted to ensure the security of the sensitive data that may be stored in the system 1.

While the inventory management systems 10, 10′, 10″ described above have been largely described with reference to their use in a hospital setting, the systems of the present application may be utilized in a variety of environments. For example, the system of the present application would be useful in a large factory, warehouse, home or even a retail store. Thus the system of the present application is not limited to use in a hospital.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An inventory management system for identifying and locating items in a facility comprises:
a plurality of identification tags, each of which includes identification information regarding an item to which each respective identification tag is attached;
a memory device including information regarding all of the items in the facility, including image information for each item;
an input device operable to receive information from a user, including a request for a desired item;
a plurality of readers positioned around the facility, wherein each reader is operable to transmit an inquiry signal that triggers one or more identification tag to emit a response signal, the response signal including the identification information regarding the item to which each tag is attached, wherein the response signal is received by at least one reader of the plurality of readers; and
a controller connected to the plurality of readers and the input device, the controller being operable to control the readers to emit the inquiry signal and to provide location information indicating a location of the desired item requested by the user based on the response signal received by the reader; wherein
the controller retrieves image information for the desired item from the memory device and wherein the location information and image information related to the desired item is displayed to the user of the system.

2. The inventory management system of claim 1, wherein the image information includes photographs of the desired item in its stored position.

3. The inventory management system of claim 2, wherein the image information also includes photographs of the desired item in its assembled state.

4. The inventory management system of claim 3, wherein the image information also includes photographs of the desired item in its disassembled state.

5. The inventory management system of claim 4, further comprising a plurality of cameras positioned around the facility and connected to the controller, wherein at least one camera of the plurality of cameras is activated by the controller in the vicinity of the desired item to provide real time image information regarding the desired item to the controller and wherein the controller selectively provides the real time image information to the user.

6. The inventory management system of claim 5, wherein the real time image information is provided to the user based on a request from the user via the input device.

7. The inventory management system of claim 5, wherein the real time image information is provided to the user when the real time image information does not match stored image information as it relates to the desired item from the memory device.

8. The inventory management system of claim 5, further comprising a plurality of designators positioned around the facility and connected to the controller, wherein at least one designator of the plurality of designators in the vicinity of the desired item is activated by the controller to designate the desired item.

9. The inventory management system of claim 8, wherein the plurality of designators are a plurality of light sources that are controlled by the controller to shine a light onto the desired item when activated.

10. The inventory management system of claim 5, wherein the controller includes a communication device operable to communicate with an external device.

11. The inventory management system of claim 11, wherein the external device is a computer system of a vendor of at least one of the items in the facility.

12. The inventory management system of claim 11, wherein the controller determines whether there is a sufficient supply of the at least one item and generates a re-order request that is sent to the vendor computer system when the controller determines that there is not a sufficient supply of the at least one item.

13. The inventory management system of claim 12, wherein the controller receives a request for additional information regarding the at least one item from the user and generates a request message that is provided to the vendor computer system via the communication device, and wherein the controller receives the requested additional information from the vendor computer system via the communication device.

14. The inventory management system of claim 13, wherein the controller generates a conference request based on a request from the user and provide the request to the vendor computer system, wherein the communication system supports a real time conference between the vendor computer system and the user.

15. The inventory management system of claim 5, further comprising a staff memory unit, connected to the controller and operable to store information regarding all potential users of the system in the facility.

16. The inventory management system of claim 15, wherein the staff memory unit stores identity information for every potential user of the system and wherein the controller requests identification information from the user and compares it to the stored identification information to authenticate the user prior to displaying the identification information and location information for the desired item.

17. The inventory management system of claim 16, wherein the staff memory unit stores at least one preference list for selected users of the system, wherein the preference list identifies a plurality of items preferred by each of the selected users.

18. The inventory management system of claim 17, further comprising a scheduling memory unit operable to store activity information regarding a plurality of planned activities within the facility, wherein the activity information includes information regarding the identity of any users participating in an activity and a time at which the activity is to take place.

19. The inventory management system of claim 18, wherein the controller compares items identified in the preference list of a user who is scheduled to participate in a planned activity prior to the planned activity to items available in the facility, and provides location information and image information regarding every item on the preference list to the user.

20. The inventory management system of claim 19, wherein the controller provides an alert to the user when any item on the preference list is not available in the facility and status information related to any missing item indicating a reason why the missing item is not available.

21. The inventory management system of claim 20, wherein the controller compares any missing item from the preference list to all available items in the facility and provides an alternative item suggestion to the user.

22. The inventory management system of claim 18, wherein the scheduling memory unit stores additional image information, wherein the additional image information includes at least one set up photograph illustrating a preferred room set up for at least one planned activity.

23. The inventory management system of claim 22, wherein the at least one set up photograph is displayed to the user based on a request from the user.

24. The inventory management system of claim 23, wherein the preferred room set up is based on a default room set up.

25. The inventory management system of claim 23, wherein the preferred room set up is based on the preference list of a user who is scheduled to participate in the planned activity.

26. The inventory management system of claim 5, further comprising a portable reader operable to emit the inquiry signal over a reduced range and to receive response signals from any identification tag within the reduced range.

27. The inventory management system of claim 26, wherein the portable reader is connected to the controller such that identification information included in the response signal of any identification tag received by the portable reader is sent to the controller.

28. The inventory management system of claim 27, wherein the controller identifies the item associated with the identification tag from which the response signal is received and maintains a list of identified items.

29. The inventory management system of claim 28, wherein the controller compares the list of identified items to a previous list, identified any items from the previous list that are not included in the list of identified items and sends an alert signal to the portable reader indicating which items are missing.

30. The inventory management system of claim 29, wherein the controller retrieves information related to any item associated with the identification tag from which a response signal is received from the item database and sends the retrieved information to the portable reader.

31. The inventory management system of claim 30, wherein the retrieved information includes image information including the photograph of the item in its stored position.
